(19) United States
(12) Patent Application Publication
(10) Pub. No.: US 2012/0294493 A1
(43) Pub. Date: Nov. 22, 2012

(54) METHOD FOR GENERATING A RESPIRATORY GATING SIGNAL IN AN X-RAY MICROGRAPHY SCANNER

(75) Inventors: Kyong Woo Kim, Iksan-si (KR); Kyu Gyeom Kim, Iksan-si (KR); Joon Whoan Lee, Jeonju-si (KR); Song Yi Shin, Jeonju-si (KR)

(73) Assignee: NANO FOCUS RAY CO., LTD, Jeonju-si, Jeollabuk-do (KR)

(21) Appl. No.: 13/522,977

(22) PCT Filed: Jul. 30, 2010
(86) PCT No.: PCT/KR2010/005023

§ 371 Date: Jul. 19, 2012

(30) Foreign Application Priority Data
Jan. 19, 2010 (KR) 10-2010-0004635

(51) Int. Cl. G06K 9/60

(52) U.S. Cl. 382/107

(57) ABSTRACT

The present disclosure relates to a method for generating a respiration gating signal of an X-ray micro-computed tomography scanner. The respiration cycle of repeating inhalation and exhalation of an experimental animal is acquired by imaging the abdomen or chest of the experimental animal respiring under anesthesia fixed on a couch disposed between an X-ray irradiator and an X-ray detector fixed to a rating gantry, and then a respiration gating signal that is synchronized at the point of time when the respiration is judged to stop.

### CROSS REFERENCE TO RELATED APPLICATIONS AND CLAIM OF PRIORITY

This patent application is a National Phase application under 35 U.S.C. §371 of International Application No. PCT/KR2010/005023, filed on Jul. 30, 2010, which claims priority to Korean Patent Application number 10-2010-0004635, filed on Jan. 19, 2010, entire contents of which are incorporated herein by reference.

### BACKGROUND

1. Technical Field

The present disclosure relates to an X-ray micro-computed tomography scanner, more particularly to a method for generating a respiration gating signal of an X-ray micro-computed tomography scanner that is synchronized with the respiration cycle of an experimental animal respiring under anesthesia and thus enables imaging.

2. Description of the Related Art

Generally, in in-vivo experiments using an X-ray micro-computed tomography scanner, a gantry having an X-ray irradiator and an X-ray detector disposed to face each other images an experimental animal respiring on a couch disposed between the X-ray irradiator and the X-ray detector under anesthesia while it rotates 360° around the animal to obtain cross-sectional images of the experimental animal.

While the X-ray micro-computed tomography scanner images the experimental animal, the motion of the experimental animal due to respiration causes motion artifacts in the obtained cross-sectional images. The motion artifact is seen as blurring in the image.

Since the motion artifact of the cross-sectional image is the main cause of the degradation of spatial resolution and signal-to-noise ratio (SNR), the experimental animal is anesthetized to prevent movement or the cross-sectional image is obtained by imaging the experimental animal when the respiration of the experimental animal is stopped (respiration gating), in order to remove the motion artifacts.

As the respiration gating methods, there are a method of anesthetizing the experimental animal to stabilize its movement during the experiment, forcibly controlling the respiration cycle of the animal using a ventilator and generating a respiration gating signal that is synchronized with the respiration cycle and thus enables imaging and a method of slowing the respiration cycle of the experimental animal by controlling the anesthetic dose, sensing the respiration cycle using an air pressure sensor attached to the abdomen or chest and generating a respiration gating signal that is synchronized with the respiration cycle and thus enables imaging.

### SUMMARY

The respiration gating method of forcibly controlling the respiration cycle of the experimental animal using a ventilator is disadvantageous in that the experimental animal tends to be brought into bad condition or die during imaging because of excessive stress.

And, the respiration gating method of slowing the respiration cycle of the experimental animal by controlling the anesthetic dose is disadvantageous in that an air pressure sensor has to be attached to the abdomen or chest of the experimental animal and the cable connected to the air pressure sensor for sensing of the change in respiration may interfere with the imaging.

The present disclosure is directed to providing a method for generating a respiration gating signal of an X-ray micro-computed tomography scanner, including acquiring the respiration cycle of repeating inhalation and exhalation of an experimental animal by imaging the abdomen or chest of the experimental animal respiring under anesthesia fixed on a couch disposed between an X-ray irradiator and an X-ray detector fixed to a rating gantry and generating a respiration gating signal that is synchronized at the point of time when the respiration is judged to stop and thus enables imaging while measuring and displaying the respiring rate (e.g. respirations per minute) required for the control of the anesthetic dose based on the acquired respiration cycle.

In one general aspect, the present disclosure provides a method for generating a respiration gating signal of an X-ray micro-computed tomography scanner, including: a first process of a camera fixed on a couch imaging the abdomen or chest of an experimental animal respiring under anesthesia fixed on the couch in real time; a second process of a respiration image display converting the image imaged by the camera in real time to a digital image and displaying it on a screen; a third process of a respiration image processor generating displacement data of a window image of a predetermined size selected by a user from the screen displayed by the respiration image display with respect to change in time; and a fourth process of a respiration recognizer acquiring the respiration cycle of the experimental animal from the displacement data with respect to change in time generated by the respiration image processor and generating a respiration gating signal that is synchronized at the point of time when the respiration is judged to stop while measuring and displaying the respiring rate required for the control of the anesthetic dose based on the acquired respiration cycle and thus enables imaging by an X-ray detector which is disposed to face an X-ray irradiator and detects X-ray irradiated from the X-ray irradiator and passing through the experimental animal to acquire a cross-sectional image.

In the third process of the method for generating a respiration gating signal of an X-ray micro-computed tomography scanner according to the present disclosure, the respiration image processor may correct the position of a current window image from the position of a previous window image by estimating motion vectors of the current window image and the previous window image based on the central coordinate of the current window image and the central coordinate of the previous window image with respect to change in time, obtain a normalized cross-correlation coefficient (NCC) representing similarity of the current window image and the previous window image at the corrected position as displacement data and transfer it to the respiration recognizer.

In the fourth process of the method for generating a respiration gating signal of an X-ray micro-computed tomography scanner according to the present disclosure, the respiration recognizer may acquire the time between the point of time when one of the normalized cross-correlation coefficient (NCC) obtained by the respiration image processor with respect to change in time changes abruptly such that the similarity between the current window image and the previous window image becomes low and the point of time when another normalized cross-correlation coefficient (NCC) changes abruptly such that the similarity between the current window image and the previous window image becomes low as the respiration cycle of the experimental animal.

In the fourth process of the method for generating a respiration gating signal of an X-ray micro-computed tomography scanner according to the present disclosure, the respiration recognizer may judge that the respiration is stopped during the time between the point of time when one of the normalized cross-correlation coefficient (NCC) changes abruptly and the point of time when another normalized cross-correlation coefficient (NCC) changes abruptly while measuring and displaying the respiring rate required for the control of the anesthetic dose based on the respiration cycle, and generate a respiration gating signal that is synchronized at the point of time delayed by the amount of time determined by the user from the point of time when the normalized cross-correlation coefficient (NCC) changes abruptly during the time when the respiration is stopped and thus enables imaging by the X-ray detector.

In accordance with the present disclosure, since the respiration gating signal that is synchronized at the point of time when the respiration of an experimental animal respiring under anesthesia is judged to stop is generated based on the automatic sensing of the respiration cycle while measuring and displaying the respiring rate required for the control of the anesthetic dose, cross-sectional images of the experimental animal with relatively better spatial resolution and signal-to-noise ratio can be obtained as compared to the respiration gating method wherein a ventilator is used to forcibly control the respiration cycle of the experimental animal or the inherent respiration cycle of the experimental animal is slowed by controlling the anesthetic dose.

### BRIEF DESCRIPTION OF DRAWINGS

FIG. 1 shows an X-ray computed tomography scanner according to an exemplary embodiment of the present disclosure.

FIG. 2 shows an example wherein the camera in FIG. 1 is fixed on a couch to image the abdomen or chest of an experimental animal respiring under anesthesia.

FIG. 3 shows a method for generating a respiration gating signal of an X-ray micro-computed tomography scanner according to an exemplary embodiment of the present disclosure.

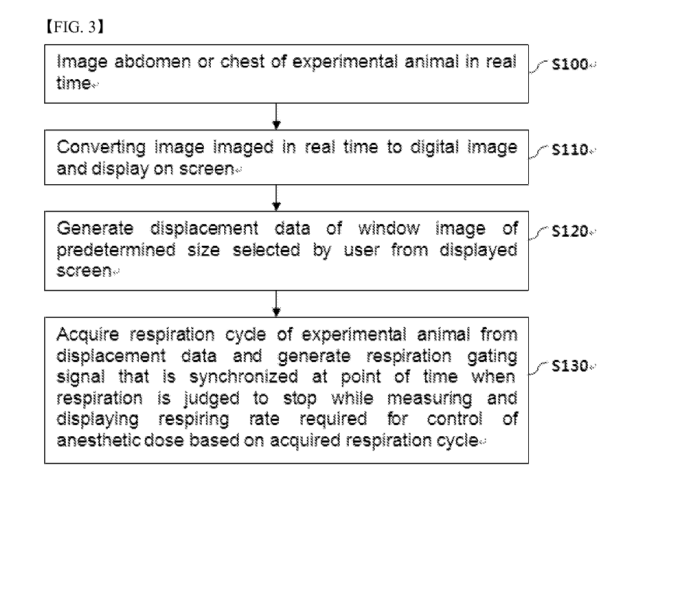

### DETAILED DESCRIPTION

Hereinafter, the embodiments of the present disclosure will be described in more detail referring to the attached drawings.

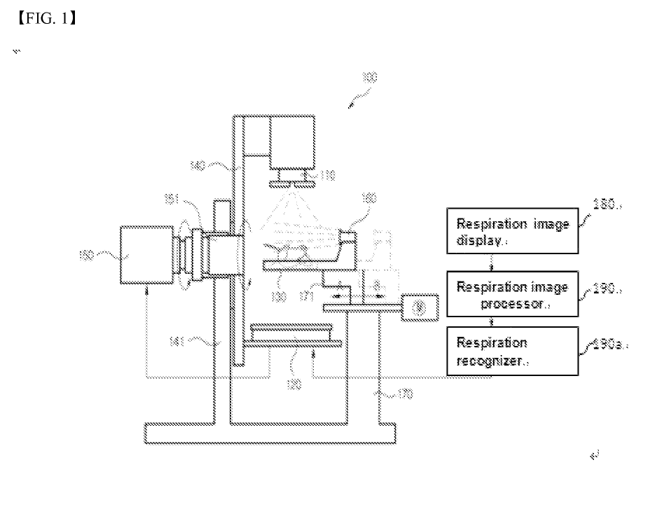

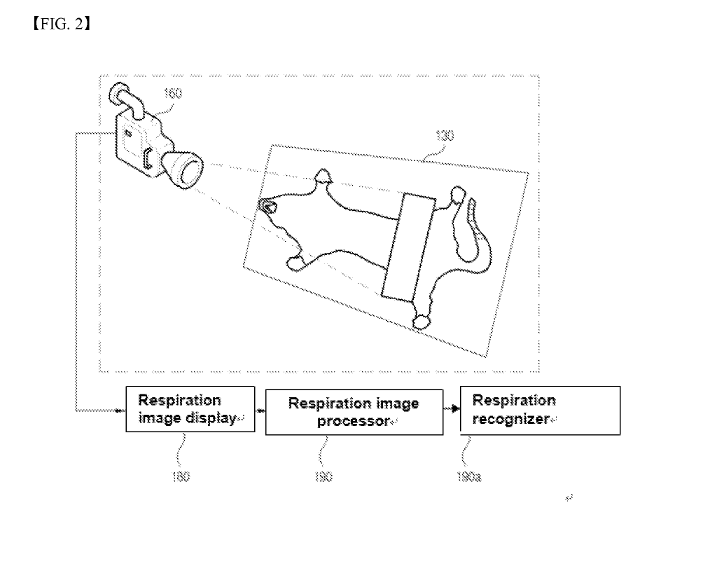

FIG. 1 shows an X-ray computed tomography scanner to which a method for generating a respiration gating signal according to an exemplary embodiment of the present disclosure is applied, and FIG. 2 shows an example wherein the camera in FIG. 1 is fixed on a couch to image the abdomen or chest of an experimental animal respiring under anesthesia.

Referring to FIG. 1 and FIG. 2, an X-ray irradiator (110) irradiates X-ray for imaging cross-sectional images.

An X-ray detector (120) disposed to face the X-ray irradiator (110) performs imaging when a respiration gating signal is input so as to detect the X-ray irradiated from the X-ray irradiator (110) and passing through an experimental animal to acquire a cross-sectional image and output an imaging completion signal.

A couch (130) is disposed between the X-ray irradiator (110) and the X-ray detector (120) and the experimental animal respiring under anesthesia is fixed thereon.

A gantry (140) having the X-ray irradiator (110) fixed at the upper end and the X-ray detector (120) fixed at the lower end is supported by a support (141).

A gantry motor (150) rotates the gantry (140) by a predetermined rotation angle around a rotating shaft (151) rotatably fixed between the upper end and the lower end of the gantry (140) when the imaging completion signal is input.

A camera (160) is fixed on one side of the couch (130) and images the abdomen or chest of the experimental animal fixed on the couch (130) and respiring under anesthesia. Specifically, it may image the abdomen or chest of the experimental animal at a rate of at least 30 frames per second.

Specifically, the camera (160) may be, for example, a CCD camera equipped with an infrared (IR) LED lighting.

A couch support (170) moves back and forth an upper plate (171) fixing the couch (130) to which the camera (160) is fixed by an electric motor (M) so as to locate the couch (130) at the center of rotation of the gantry between the X-ray irradiator (110) and the X-ray detector (120) or to move the couch (130) away from the position between the X-ray irradiator (110) and the X-ray detector (120) for exchange of sample (e.g., the experimental animal).

Since the mechanism by which the upper plate (171) of the couch support (170) is moved back and forth by the electric motor (M) shown in FIG. 1 may be easily and variously embodied within the level of those skilled in the art, for example, using balls and screws or using an LM guide, a detailed description thereof will be omitted.

A respiration image display (180) converts the image imaged by the camera (160) which is fixed on the couch (130) and images the abdomen or chest of the experimental animal respiring under anesthesia in real time to a digital image and displays it on a screen.

A respiration image processor (190) generates displacement data of a window image of a predetermined size selected by a user from the screen displayed by the respiration image display (180) with respect to change in time.

The respiration image processor (190) corrects the position of the current window image from the position of a previous window image by estimating motion vectors of the current window image and the previous window image based on the central coordinate of the current window image and the central coordinate of the previous window image with respect to change in time, obtains a normalized cross-correlation coefficient (NCC) representing similarity of the current window image and the previous window image at the corrected position as displacement data and transfers it to a respiration recognizer (190a).

The respiration image processor (190) may correct the position of the current window image from the position of a previous window image by estimating the motion vectors of the current window image and the previous window image based on the central coordinate of the current window image and the central coordinate of the previous window image using, for example, the scale-invariant feature transform (SIFT) method of extracting local features irrelevant of size from the image of the experimental animal and estimating/correcting motion based on the features. Since the SIFT method can be easily understood within the level of those skilled in the art, a detailed description thereof will be omitted.

The respiration recognizer (190a) acquires the respiration cycle of the experimental animal from the displacement data with respect to change in time generated by the respiration image processor (190) and generates a respiration gating signal that is synchronized at the point of time when the respiration is judged to stop and thus enables imaging by the X-ray detector (120) while measuring and displaying the respiring rate required for the control of the anesthetic dose based on the acquired respiration cycle.

The respiration recognizer (190a) obtains the normalized cross-correlation coefficient (NCC) representing similarity of the current window image and the previous window image using the following equation 1:

$$NCC ( i , j , d , v ) = \frac{{\sum }_{m = i - L}^{i + L} {\sum }_{n = j - K}^{j + K} F ( m , n ) * G ( m + v , n + d )}{\begin{matrix}\sqrt{{\sum }_{m = i - L}^{i + L} {\sum }_{n = j - K}^{j + K} {F}^{2} ( m , n )} * \\ \sqrt{{\sum }_{m = i - L}^{i + L} {\sum }_{n = j - K}^{j + K} {G}^{2} ( m + v , n + d )}\end{matrix}} \qquad [ Equation 1 ]$$

wherein NCC(i, j, d, v) is the normalized cross-correlation coefficient of the current window image (F) and the previous window image (G) centered around (i, j) and (d, v) and having sizes K and L and has a value between −1 and 1 (The value close to ‘1’ means higher similarity between the two window images and the value close to ‘0’ means lower similarity between the two window images.), F(m, n) is the brightness of the current window image (F) at the position (m, n), and G(m+v, n+d) is the brightness of the previous window image (G) at the position (m+v, n+d).

The respiration recognizer (190a) acquires the time between the point of time when one of the normalized cross-correlation coefficient (NCC) obtained by the respiration image processor (190) with respect to change in time changes abruptly such that the similarity between the current window image and the previous window image becomes low and the point of time when another normalized cross-correlation coefficient (NCC) changes abruptly such that the similarity between the current window image and the previous window image becomes low as the respiration cycle of the experimental animal.

The respiration recognizer (190a) judges that the respiration is stopped during the time between the point of time when one of the normalized cross-correlation coefficient (NCC) changes abruptly and the point of time when another normalized cross-correlation coefficient (NCC) changes abruptly while measuring and displaying the respiring rate required for the control of the anesthetic dose based on the respiration cycle, and generates a respiration gating signal that is synchronized at the point of time delayed by the amount of time determined by the user from the point of time when the normalized cross-correlation coefficient (NCC) changes abruptly during the time when the respiration is stopped and thus enables imaging by the X-ray detector (120).

A method for generating a respiration gating signal according to an exemplary embodiment of the present disclosure applied to the X-ray computed tomography scanner (100) is performed as follows.

First, the camera (160) fixed on the couch (130) images the abdomen or chest of the experimental animal respiring under anesthesia fixed on the couch in real time (S100).

Before the imaging is started, the user moves the upper plate (171) of the couch support (170) for exchange of sample between the X-ray irradiator (110) and the X-ray detector (120) by moving the couch (130) on which the camera (160) is fixed toward the direction A in FIG. 1 such that X-ray is not irradiated to the experimental animal, and then fixes the experimental animal respiring under anesthesia on the couch (130).

Subsequently, when the user turns on the camera (160), the camera (160) images the abdomen or chest of the experimental animal fixed on the couch (130) and respiring under anesthesia in real time at a rate of at least 30 frames per second and transfers the image to the respiration image display (180). Then, the respiration image display (180) converts the image imaged by the camera (160) in real time to a digital image and displays it on a screen (S110).

Subsequently, the respiration image processor (190) generates the displacement data of the window image of a predetermined size selected by the user from the screen displayed by the respiration image display (180) with respect to change in time (S120).

Specifically, the user may select the window image to include the abdomen or chest of the experimental animal. For example, after marking a specific position of the abdomen or chest of the experimental animal (e.g., the navel or the center of the abdomen or chest) with a pen or ink for easy monitoring of the positional change of the window image, a window image of a predetermined size may be selected with the mark as the central coordinate. In this case, it is easier to estimate the motion vectors to be corrected.

The respiration image processor (190) corrects the position of the current window image from the position of the previous window image by estimating the motion vectors of the current window image and the previous window image based on the central coordinate of the current window image and the central coordinate of the previous window image with respect to change in time, obtains the normalized cross-correlation coefficient (NCC) representing similarity of the current window image and the previous window image at the corrected position as displacement data and transfers it to the respiration recognizer (190a).

For example, as described above referring to the equation 1, the respiration image processor (190) corrects the position of the current window image (F) from the position of the previous window image (G) by estimating the motion vectors of the current window image (F) and the previous window image (G) based on the central coordinate of the current window image (F) centered around (i, j) and having size K and the previous window image (G) centered around (d, v) and having size L.

If the respiration of the experimental animal is stopped, the normalized cross-correlation coefficients (NCCs) representing similarity of the current window image (F) and the previous window image (G) at the corrected position are equal or similar. For example, the value is close to ‘1’ and the two images have high similarity.

Otherwise, if the experimental animal is respiring, the normalized cross-correlation coefficients (NCCs) representing similarity of the current window image (F) and the previous window image (G) at the corrected position become quite different due to abrupt change. For example, the value is close to ‘0’ and the two images have low similarity.

After the displacement data with respect to change in time is generated by the respiration image processor (190) (S120), the respiration recognizer (190a) finally acquires the respiration cycle of the experimental animal from the displacement data with respect to change in time generated by the respiration image processor (190) and generates a respiration gating signal that is synchronized at the point of time when the respiration is judged to stop while measuring and displaying the respiring rate required for the control of the anesthetic dose based on the acquired respiration cycle and thus enables imaging by an X-ray detector (120) which is disposed to face an X-ray irradiator (110) and detects X-ray irradiated from the X-ray irradiator (110) and passing through the experimental animal to acquire a cross-sectional image (S130).

The respiration recognizer (190a) acquires the time between the point of time when one of the normalized cross-correlation coefficient (NCC) obtained by the respiration image processor (190) with respect to change in time changes abruptly such that the similarity between the current window image and the previous window image becomes low and the point of time when another normalized cross-correlation coefficient (NCC) changes abruptly such that the similarity between the current window image and the previous window image becomes low as the respiration cycle of the experimental animal, and measures and displays the respiring rate required for the control of the anesthetic dose based on the respiration cycle.

Then, the user controls the anesthetic dose until the respiring rate (e.g., 20-30 respirations per minute) optimized for imaging the cross-sectional image of the experimental animal is reached.

After the anesthetic dose is controlled, the respiration recognizer (190a) judges that the respiration is stopped during the time between the point of time when one of the normalized cross-correlation coefficient (NCC) changes abruptly and the point of time when another normalized cross-correlation coefficient (NCC) changes abruptly while measuring and displaying the respiring rate required for the control of the anesthetic dose based on the respiration cycle, and generates a respiration gating signal that is synchronized at the point of time delayed by the amount of time determined by the user from the point of time when the normalized cross-correlation coefficient (NCC) changes abruptly during the time when the respiration is stopped and thus enables imaging by the X-ray detector (120). That is to say, a respiration gating signal synchronized with the respiration cycle of the experimental animal is generated at the point of time when the respiration of the experimental animal is stopped.

The user may determine, while monitoring the respiring rate optimized for imaging the cross-sectional image of the experimental animal (e.g., 20-30 respirations per minute) displayed by the respiration recognizer (190a), the time delay such that the respiration gating signal is generated, within the time range between the point of time when one of the normalized cross-correlation coefficient (NCC) changes abruptly and the point of time when another normalized cross-correlation coefficient (NCC) changes abruptly, at the point of time delayed from the point of time when the one of the normalized cross-correlation coefficient (NCC), i.e. the former normalized cross-correlation coefficient (NCC), changes abruptly. Accordingly, the respiration recognizer (190a) generates the respiration gating signal which is synchronized at the time delayed by the user.

Subsequently, the user moves the upper plate (171) of the couch support (170) toward the direction B in FIG. 1 such that X-ray is irradiated to the experimental animal. After the upper plate (171) of the couch support (170) is disposed at the center of rotation of the gantry between the X-ray irradiator (110) and the X-ray detector (120), the X-ray irradiator (110) and the X-ray detector (120) are operated.

When the respiration gating signal synchronized with the respiration cycle of the experimental animal generated by the respiration recognizer (190a) is input to the X-ray detector (120), the X-ray detector (120) obtains the cross-sectional image by detecting the X-ray irradiated from the X-ray irradiator (110) and passing the experimental animal, outputs an imaging completion signal and transfers it to the gantry motor (150).

Then, the gantry motor (150) rotates the gantry (140) by a predetermined rotation angle (e.g., 0.7-1°) and stands by until the input of the next imaging completion signal which is output after the X-ray irradiator (110) obtains the cross-sectional image.

After the rotation of the gantry (140) by the gantry motor (150) is completed up to 360°, the user stops the operation of the X-ray irradiator (110) and the X-ray detector (120) and moves the upper plate (171) of the couch support (170) toward the direction A in FIG. 1 so as to remove it from between the X-ray irradiator (110) and the X-ray detector (120). Then, the user removes the experimental animal fixed to the couch (130) from the couch (130).

The method for generating a respiration gating signal of an X-ray micro-computed tomography scanner according to the present disclosure described above may be readily utilized as a basis for modifying or designing other embodiments for carrying out the same purposes of the present disclosure. Those skilled in the art will also appreciate that such equivalent embodiments do not depart from the spirit and scope of the disclosure as set forth in the appended claims.

1. A method for generating a respiration gating signal of an X-ray micro-computed tomography scanner, comprising:
imaging in real time an abdomen or a chest of an animal respiring under anesthesia by a camera;
converting the image imaged by the camera in real time to a digital image and displaying it on a screen by a respiration image display;
generating displacement data of a window image of a predetermined size selected by a user from the screen displayed by the respiration image display with respect to change in time by a respiration image processor; and
with a respiration recognizer, acquiring a respiration cycle of the animal from the displacement data with respect to change in time generated by the respiration image processor and generating a respiration gating signal that is synchronized at the point of time when a respiration is judged to stop while measuring and displaying a respiring rate required for a control of an anesthetic dose based on the acquired respiration cycle and enables imaging by an X-ray detector which is disposed to face an X-ray irradiator and detects X-ray passing through the animal after the X-ray irradiator irradiates an X-ray to acquire a cross-sectional image.

2. The method claim 1, wherein, in generating the displacement data, the respiration image processor corrects a position of a current window image from a position of a previous window image by estimating motion vectors of the current window image and the previous window image based on a central coordinate of the current window image and a central coordinate of the previous window image with respect to change in time, obtains a normalized cross-correlation coefficient (NCC) representing similarity of the current window image and the previous window image at the corrected position as displacement data and transfers it to the respiration recognizer.

3. The method claim 2, wherein, in generating the displacement data, the respiration recognizer obtains the normalized cross-correlation coefficient (NCC) representing similarity of the current window image and the previous window image using the following equation:
$$NCC ( i , j , d , v ) = \frac{{\sum }_{m = i - L}^{i + L} {\sum }_{n = j - K}^{j + K} F ( m , n ) * G ( m + v , n + d )}{\begin{matrix}\sqrt{{\sum }_{m = i - L}^{i + L} {\sum }_{n = j - K}^{j + K} {F}^{2} ( m , n )} * \\ \sqrt{{\sum }_{m = i - L}^{i + L} {\sum }_{n = j - K}^{j + K} {G}^{2} ( m + v , n + d )}\end{matrix}}$$
wherein NCC(i, j, d, v) is the normalized cross-correlation coefficient of the current window image (F) and the previous window image (G) centered around (i, j) and (d, v) and having sizes K and L and has a value between −1 and 1 (The value close to ‘1’ means higher similarity between the two window images and the value close to ‘0’ means lower similarity between the two window images.), F(m, n) is the brightness of the current window image (F) at the position (m, n), and G(m+v, n+d) is the brightness of the previous window image (G) at the position (m+v, n+d).

4. The method of claim 2, wherein, the respiration recognizer acquires the time between the point of time when one of the normalized cross-correlation coefficient (NCC) obtained by the respiration image processor with respect to change in time changes abruptly such that the similarity between the current window image and the previous window image becomes low and the point of time when another normalized cross-correlation coefficient (NCC) changes abruptly such that the similarity between the current window image and the previous window image becomes low as the respiration cycle of the experimental animal.

5. The method of claim 4, wherein, the respiration recognizer judges that the respiration is stopped during the time between the point of time when one of the normalized cross-correlation coefficient (NCC) changes abruptly and the point of time when another normalized cross-correlation coefficient (NCC) changes abruptly while measuring and displaying the respiring rate required for the control of the anesthetic dose based on the respiration cycle, and generates a respiration gating signal that is synchronized at the point of time delayed by the amount of time determined by the user from the point of time when the normalized cross-correlation coefficient (NCC) changes abruptly during the time when the respiration is stopped and thus enables imaging by the X-ray detector.
